(19) United States
(12) Patent Application Publication
(10) Pub. No.: US 2025/0087405 A1
(43) Pub. Date: Mar. 13, 2025

(54) REACTOR, CONVERTER, AND POWER CONVERSION DEVICE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Takehito KOBAYASHI, Mie (JP); Kazuhiro INABA, Mie (JP)

(21) Appl. No.: 18/564,606

(22) PCT Filed: Jun. 8, 2022
(86) PCT No.: PCT/JP2022/023143

§ 371 Date: Nov. 27, 2023

(30) Foreign Application Priority Data
Jun. 10, 2021 (JP) 2021-097095

(51) Int. Cl. H01F 27/28; H01F 27/24; H01F 27/29; H02M 7/537

(52) U.S. Cl. CPC H01F 27/2823; H01F 27/24; H01F 27/29; H02M 7/537

(57) ABSTRACT

A reactor includes an edgewise coil constituted by a flat wire; a magnetic core where the coil is disposed; and a holding member disposed on at least one end section of the coil, in which the coil includes a main body portion constituted by a plurality of turns, and a first terminal section that is drawn out from one end section of the main body portion in a direction extending along an end surface of the main body portion, the holding member includes a first surface facing the end surface of the main body portion and a fixing portion that holds the first terminal section, and the fixing portion has a slit through the first terminal section is passed.

### TECHNICAL FIELD

The present disclosure relates to a reactor, a converter, and a power conversion device.

This application is based upon and claims the benefit of priority from Japanese Patent Application No. 2021-097095 filed Jun. 10, 2021, the entire content of which is hereby incorporated by reference.

### BACKGROUND

Patent Document 1 discloses a reactor provided with a coil, a core, and frame-shaped bobbins. The coil is an edgewise coil constituted by a flat wire. The frame-shaped bobbins are respectively disposed at two end sections of the coil.

### PRIOR ART DOCUMENT

### Patent Document

Patent Document 1: JP 2009-246220 A

### SUMMARY OF THE INVENTION

A reactor according to the present disclosure includes an edgewise coil constituted by a flat wire; a magnetic core where the coil is disposed; and a holding member disposed on at least one end section of the coil, in which the coil includes a main body portion constituted by a plurality of turns, and a first terminal section that is drawn out from one end section of the main body portion in a direction extending along an end surface of the main body portion, the holding member includes a first surface facing the end surface of the main body portion and a fixing portion that holds the first terminal section, and the fixing portion has a slit through which the first terminal section is passed.

A converter according to the present disclosure includes the reactor of the present disclosure.

A power conversion device according to the present disclosure includes the converter of the present disclosure.

### BRIEF DESCRIPTION OF THE DRAWINGS

FIG. 1 is a schematic top view showing one example of a reactor according to an embodiment.

FIG. 2 is a schematic exploded top view showing one example of the reactor according to the embodiment.

FIG. 3 is a schematic perspective view showing one example of a coil used in the reactor according to the embodiment.

FIG. 4 is a schematic perspective view showing a state in which the coil used in the reactor according to the embodiment and holding members are assembled to each other.

FIG. 5 is a schematic diagram of an end surface of the coil used in the reactor according to the embodiment as seen in an axial direction.

FIG. 6 is a schematic cross-sectional view illustrating a cross-section taken along line VI-VI in FIG. 5.

FIG. 7 is a schematic top view illustrating a state in which the coil used in the reactor according to the embodiment and the holding members are separated from each other.

FIG. 8 is a schematic diagram illustrating a configuration of a bending-processing portion in a winding machine used to manufacture the coil used in the reactor according to the embodiment.

FIG. 9 is a schematic diagram illustrating operation of the bending-processing portion.

FIG. 10 is another schematic diagram illustrating operation of the bending-processing portion.

FIG. 11 is a schematic diagram illustrating a method for manufacturing the coil used in the reactor according to the embodiment.

FIG. 12 is a schematic top view illustrating a state in which the coil used in the reactor according to the embodiment, a magnetic core, and the holding members are assembled to each other.

FIG. 13 is a schematic diagram of an end surface of a first holding member shown in FIG. 4 as seen from the first surface side.

FIG. 14 is a schematic perspective view of the first holding member shown in FIG. 4 as seen from the first surface side.

FIG. 15 is a schematic top view of the first holding member shown in FIG. 4.

FIG. 16 is a schematic perspective view of a second holding member shown in FIG. 4 as seen from the opposite side to the first surface side shown in FIG. 4.

FIG. 17 is a schematic diagram of an end surface of the second holding member shown in FIG. 4 as seen from the first surface side.

FIG. 18 is a configuration diagram schematically showing a power supply system of a hybrid automobile.

FIG. 19 is a circuit diagram illustrating an overview of one example of a power conversion device provided with a converter.

### DETAILED DESCRIPTION TO EXECUTE THE INVENTION

### Problems to be Solved

There is demand for improving operability for connecting a busbar to a terminal section of a coil. Two end sections of the coil are provided with the terminal sections to be connected to busbars. The terminal sections may be drawn out from an end section of the coil in a direction orthogonal to the axial direction of the coil. A busbar is a member that electrically connects an external electric circuit and the coil to each other.

Because the frame-shaped bobbins are only in contact with end surfaces of the coil in the reactor of Patent Document 1, the positions of terminal sections of the coil may not be sufficiently regulated. Depending on the structure of a contact surface of the frame-shaped bobbin that is in contact with a coil end surface, the terminal section may move in a direction away from the contact surface. If the position of the terminal section is not constant, there is a risk that the terminal section and the busbar will separate from each other and welding between the two will not be possible, or even if the terminal section and the busbar are welded to each other, bonding strength may be insufficient. Deterioration in the operability for connecting a terminal section of the coil and a busbar to each other may lead to a decrease in the productivity of devices such as a converter provided with a reactor.

The present disclosure aims to provide a reactor capable of regulating the position of a terminal section of a coil. Another object of the present disclosure is to provide a converter provided with the reactor, and a power conversion device provided with the converter.

### Effect of the Invention

The reactor according to the present disclosure is capable of regulating the position of a terminal section of a coil.

The converter according to the present disclosure, and the power conversion device according to the present disclosure have high productivity.

### Description of Embodiments of the Present Disclosure

First, embodiments of the present disclosure will be listed and described.

(1) A reactor according to an embodiment of the present disclosure includes an edgewise coil constituted by a flat wire; a magnetic core where the coil is disposed; and a holding member disposed on at least one end section of the coil, in which the coil includes a main body portion constituted by a plurality of turns, and a first terminal section that is drawn out from one end section of the main body portion in a direction extending along an end surface of the main body portion, the holding member includes a first surface facing the end surface of the main body portion and a fixing portion that holds the first terminal section, and the fixing portion has a slit through which the first terminal section is passed.

The reactor according to the present disclosure is capable of regulating the position of the first terminal section of the coil using the holding member. The position of the first terminal section is regulated by inserting the first terminal section into the slit formed in the fixing portion, at the end section of the main body portion of the coil. As a result, the positional accuracy of the first terminal section is improved, thus improving the operability for connecting the busbar to the first terminal section. In particular, this is effective when automating the operation for connecting the terminal section of the coil and the busbar to each other.

The holding member is easily assembled to the end section of the main body portion by sliding the holding member in a direction extending along the end surface of the main body portion. By sliding the holding member, the first terminal section can be inserted into the slit.

(2) In the reactor according to (1) above, the plurality of turns each may include an inner peripheral section that constitutes an inner peripheral side of the turn of the flat wire, and an outer peripheral section that constitutes an outer peripheral side of the turn of the flat wire, and the outer peripheral section may be bent to be inclined with respect to the inner peripheral section in a first direction of an axial direction of the main body portion.

The configuration according to (2) above allows the first terminal section to remain open in the first direction at the end section of the main body portion in a state where nothing is assembled to the coil. When the holding member is to be assembled to the end section of the main body portion by sliding the holding member, the first terminal section can be readily inserted into the slit. Therefore, the operability for assembling the holding member to the coil is improved.

(3) In the reactor according to (2) above, the plurality of turns may each include a corner section obtained by bending the flat wire, and a displacement amount between the inner peripheral section and the outer peripheral section at the corner section in the axial direction of the main body portion may be 0.1 mm or more and 0.5 mm or less.

The configuration according to (3) above is likely to keep the first terminal section open in the first direction of the axial direction of the main body portion.

(4) In the reactor according to any one of (1) to (3) above, the first surface may have a first region. The first region presses a turn of the plurality of turns that is in contact with the first surface, in a second direction of an axial direction of the main body portion.

With the configuration according to (4) above, the first terminal section is corrected in the direction extending along the end surface of the main body portion by pressing the turn that is in contact with the first surface in the second direction. Accordingly, the positional accuracy of the first terminal section is improved.

(5) In the reactor according to any one of (1) to (4) above, the magnetic core may include an inner core portion disposed inward of the main body portion, and the holding member may include a through hole into which an end portion of the inner core portion is inserted, and an inner protrusion disposed between the main body portion and the inner core portion.

With the configuration according to (5) above, the distance between the main body portion and the inner core portion can be maintained by the inner protrusion.

(6) A converter according to an embodiment of the present disclosure includes the reactor according to any one of (1) to (5) above.

The converter according to the present disclosure includes the reactor, thus facilitating the operation for connecting the terminal section of the coil and the busbar to each other. Therefore, the converter according to the present disclosure has high productivity.

(7) A power conversion device according to an embodiment of the present disclosure includes the converter according to (6) above.

The power conversion device according to the present disclosure includes the converter, and thus has excellent productivity.

### Details of Embodiments of the Present Disclosure

Specific examples of a reactor, a converter, and a power conversion device according to the present disclosure will be described below with reference to the drawings. The same reference numerals in the drawings indicate the same or equivalent components. Note that the present invention is not limited to these examples, and is defined by the claims, and all changes that come within the meaning and range of equivalency of the claims are intended to be embraced therein.

### <Overview of Reactor>

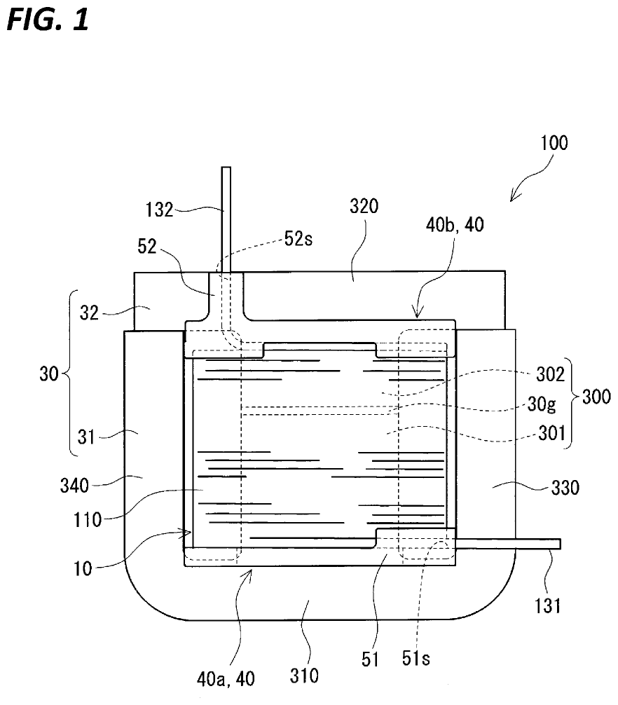

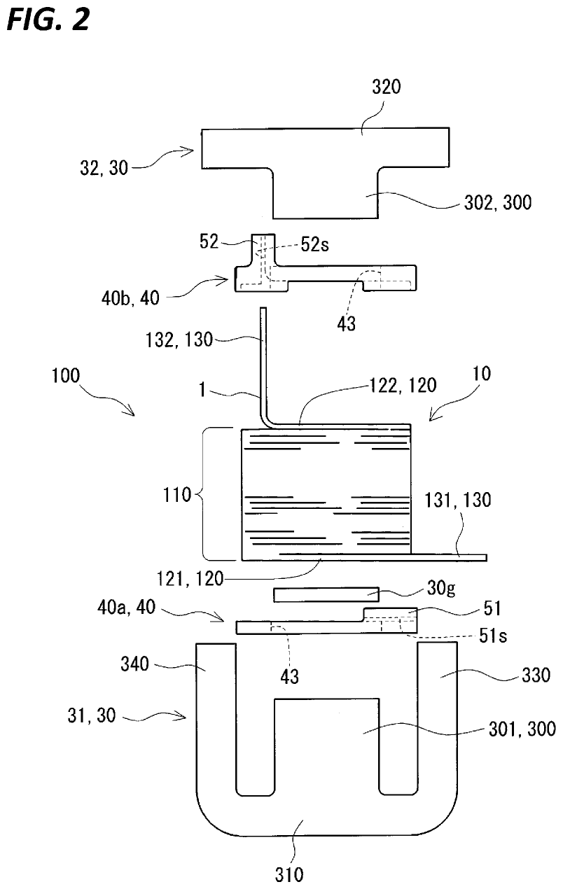

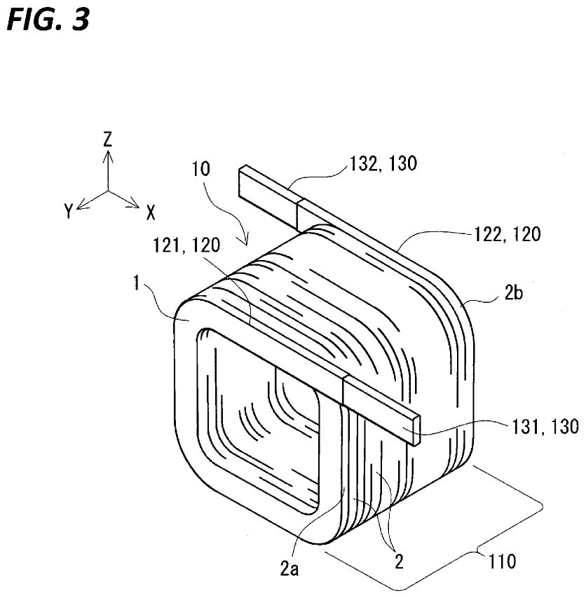

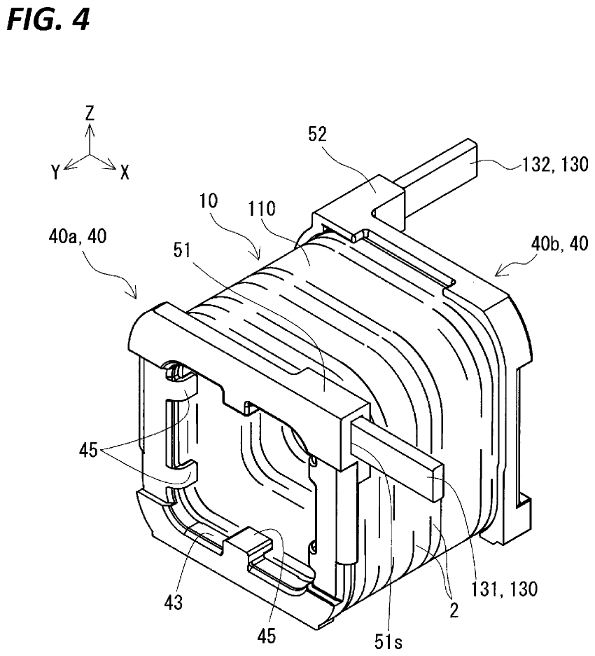

An overview of a reactor 100 according to an embodiment will be described below. As shown in FIGS. 1 and 2, the reactor 100 includes a coil 10, a magnetic core 30, and holding members 40. As shown in FIG. 3, the coil 10 includes a main body portion 110 and terminal sections 130. In this embodiment, a first terminal section 131 and a second terminal section 132 are provided as the terminal sections 130. The holding members 40 are disposed at end sections of the coil 10. In this embodiment, as shown in FIG. 4, a first holding member 40a and a second holding member 40b are provided as the holding members 40. One of the characteristics of the reactor 100 is that the first terminal section 131 and the first holding member 40a have specific structures. Hereinafter, a configuration of the reactor 100 will be described in detail.

### (Coil)

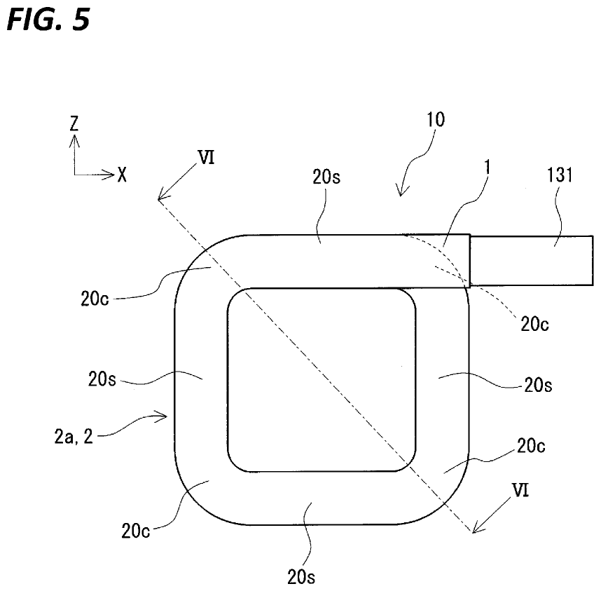

An overview of the coil 10 will be described below mainly with reference to FIGS. 3 and 5. The coil 10 is an edgewise coil constituted by a flat wire 1. FIG. 3 shows a state where the second terminal section 132 is not yet bent flatwise in the axial direction of the coil 10 while the flat wire 1 is formed in the shape of the coil 10 shown in FIG. 2. FIG. 5 is a diagram of the coil 10 shown in FIG. 3 as seen from a first end section 121 side in the axial direction of the coil 10. The second terminal section 132 is not shown in FIG. 5.

The side on which the terminal sections 130 are provided is referred to as the top side in the following description. It is presumed that the end surface of the coil 10 on the first end section 121 side is the front, and the end surface of the coil 10 on a second end section 122 is the back. It is presumed that the right side of the coil 10 is the right and the left side thereof is the left when the coil 10 is viewed from the front to the back. In the drawings, an X arrow indicates the right direction, a Y arrow indicates the axial direction, and a Z arrow indicates the upward direction.

### (Flat Wire)

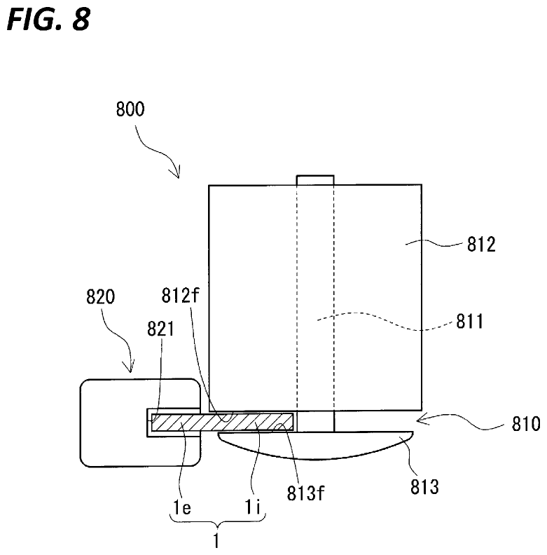

The flat wire 1 is a winding wire that has a rectangular cross-section. The cross-section refers to a cross-section that is orthogonal to the longitudinal direction of the flat wire 1. The rectangular cross-section has a pair of short sides and a pair of long sides akin to the flat wire 1 shown in FIG. 8. The width of the flat wire 1 refers to the distance between opposing short sides, and is equivalent to the length of a long side. The width direction of the flat wire 1 is substantially a direction extending along a long side of the rectangle. The thickness of the flat wire 1 refers to the distance between opposing long sides, and is equivalent to the length of a short side. The thickness direction of the flat wire 1 is substantially a direction extending along a short side of the rectangle. The width and the thickness of the flat wire 1 can be selected as appropriate. The width of the flat wire 1 is, for example, 3 mm or more and 15 mm or less, and 5 mm or more and 12 mm or less. The thickness of the flat wire 1 is, for example, 0.5 mm or more and 5 mm or less, and 0.8 mm or more and 3 mm or less.

### (Main Body Portion)

As shown in FIG. 3, the main body portion 110 is formed by edgewise winding the flat wire 1 into a helical shape. The main body portion 110 is constituted by a plurality of turns 2. The main body portion 110 includes the first end section 121 and the second end section 122. The first end section 121 is one end section in the axial direction of the main body portion 110. The second end section 122 is the other end section of the main body portion 110 in the axial direction.

The shape of the main body portion 110 may be cylindrical or rectangular tubular in shape. The term “cylindrical” indicates that the shape of an end surface of the main body portion 110 as seen in the axial direction is a circular shape. Examples of the circular shape include not only a perfectly circular shape but also an elliptical shape. The term “rectangular tubular” indicates that the shape of the end surface is a polygonal shape. Examples of the polygonal shape include a triangular shape, a quadrangular shape, a hexagonal shape, and an octagonal shape. Examples of the quadrangular shape include a rectangular shape and a trapezoidal shape. Examples of the rectangular shape include a square shape. In this embodiment, the main body portion 110 has a rectangular tubular shape. The end surfaces of the main body portion 110 have a rectangular shape.

The shape of each turn 2 is substantially the same as the shape of the end surface of the main body portion 110 described above. The shape of the turn 2 refers to the shape of the turn 2 as seen in the axial direction. In this embodiment, as shown in FIG. 5, the shape of the turn 2 is rectangular. The turn 2 has four straight sections 20s where the flat wire 1 is disposed linearly, and four corner sections 20c where the flat wire 1 is bent.

The number of turns 2 can be selected as appropriate. The number of turns 2 is 10 or more and 60 or less, and 20 or more and 50 or less, for example.

### (Terminal Section)

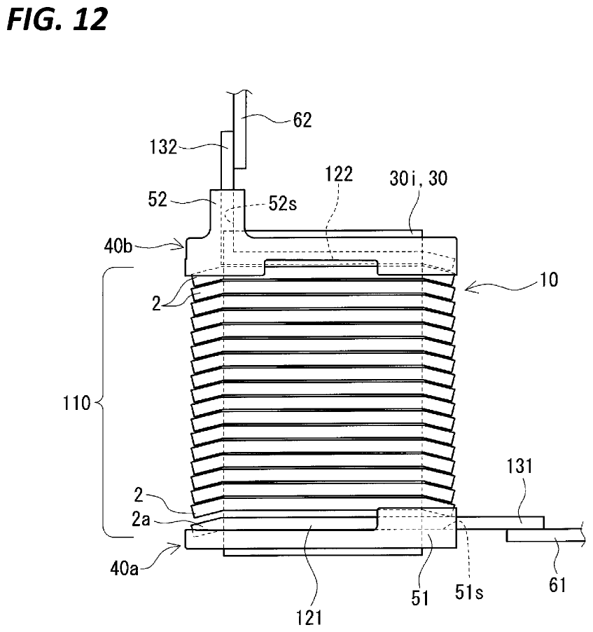

As shown in FIG. 3, the terminal sections 130 are portions obtained by drawing out the flat wire 1 from the end sections 120 of the main body portion 110 in the axial direction. Each terminal section 130 protrudes outward from the contour of the main body portion 110. The first terminal section 131 of the terminal section 130 is drawn out from the first end section 121. The second terminal section 132 is drawn out from the second end section 122. As shown in FIG. 12, busbars 61 and 62 are respectively connected to the first terminal section 131 and the second terminal section 132.

### <First Terminal Section>

As shown in FIG. 3, the first terminal section 131 is drawn out in a direction extending along the end surface on the first end section 121 side of the main body portion 110. The direction extending along the end surface of the main body portion 110 intersects the axial direction of the main body portion 110. The first terminal section 131 is continuous with a first end section turn 2a, out of the plurality of turns 2 that constitute the main body portion 110, which is located on the first end section 121 side. The first end section turn 2a constitutes the end surface on the first end section 121 side. In this embodiment, as shown in FIG. 5, the first terminal section 131 is drawn out in the direction in which an upper straight section 20s of the first end section turn 2a extends. The first terminal section 131 is continuous with the straight section 20s and extends rightward. Unlike this embodiment, the first terminal section 131 may be bent edgewise in a direction orthogonal to the axial direction of the main body portion 110, and the first terminal section 131 may be drawn out to be orthogonal to the direction in which the straight section 20s extends.

### <Second Terminal Section>

As shown in FIG. 3, the second terminal section 132 is continuous with a second end section turn 2b, out of the plurality of turns 2 that constitute the main body portion 110, which is located on the second end section 122 side. The second end section turn 2b constitutes the end surface on the second end section 122 side. In this embodiment, unlike the first terminal section 131, as shown in FIG. 2, the second terminal section 132 is drawn out in a direction extending in the axial direction of the main body portion 110 before the reactor 100 is assembled thereto. Unlike this embodiment, similarly to the first terminal section 131, the second terminal section 132 may be drawn out in a direction extending along the end surface of the main body portion 110 on the second end section 122 side. In this case, as shown in FIG. 3, the second terminal section 132 is continuous with an upper straight section of the second end section turn 2b and is drawn out leftward.

### <<Details of Coil>>

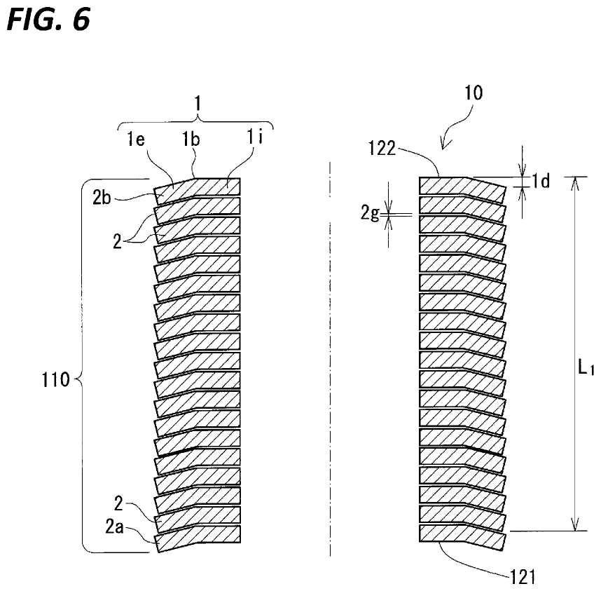

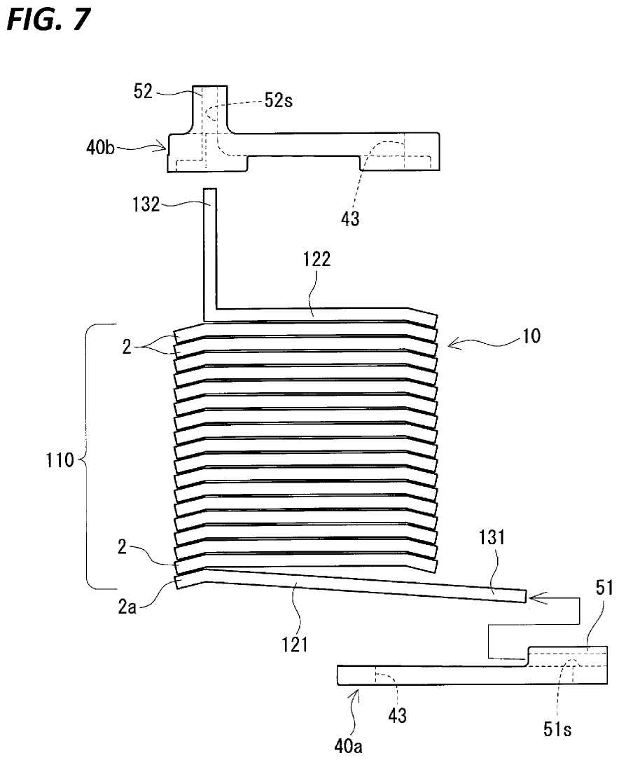

A configuration of the coil 10 in this embodiment will be described below with reference to FIGS. 6 and 7. FIG. 6 shows only cut sections of a cross-section taken along line VI-VI in FIG. 5. A configuration visible beyond the cut sections is not shown in FIG. 6. The line VI-VI in FIG. 5 is a diagonal line of a turn 2. One of the characteristics of the coil 10 is that the flat wire 1 that forms the turns 2 in the main body portion 110 has a specific shape. The configuration of the coil 10 and the configuration of the holding member 40 are schematically shown in a simplified manner in FIGS. 6 and 7. FIG. 7 shows only the coil 10 without the holding member 40 assembled thereto. The holding members 40 will be described later.

As shown in FIG. 6, the plurality of turns 2 that constitute the main body portion 110 each have an inner peripheral section 1i and an outer peripheral section 1e. The inner peripheral section 1i constitutes the inner peripheral side of a turn 2 of the flat wire 1. The outer peripheral portion 1e constitutes the outer peripheral side of the turn 2 of the flat wire 1. The outer peripheral section 1e is bent to be inclined with respect to the inner peripheral section 1i in a first direction of the axial direction of the main body portion 110. In other words, the flat wire 1 forming the turns 2 is bent partway in the width direction of the flat wire 1. The inner peripheral section 1i and the outer peripheral section 1e are continuous with each other via a bent section 1b. The inner peripheral section 1i is a portion of the flat wire 1 located on the inner peripheral side of the turn 2 relative to the bent section 1b. The outer peripheral section 1e is a portion of the flat wire 1 located on the outer peripheral side of the turn 2 relative to the bent section 1b. In this embodiment, at corner sections 20c and straight sections 20s that are shown in FIG. 5, the flat wire 1 of the turn 2 is bent partway in the width direction.

The inner peripheral section 1i extends substantially in a radial direction from the inner peripheral side of the turn 2 toward the outer peripheral side thereof as seen in a cross-section extending in the axial direction of the main body portion 110. That is, the inner peripheral section 1i extends substantially parallel to the radial direction of the turn 2. The part where the inner peripheral section 1i deviates from the radial direction due to the winding pitch of the flat wire 1 is considered to extend in the radial direction.

The first direction refers to a direction from another end section of the main body portion 110 in the axial direction to one end section thereof. That is, the first direction is a direction extending from the second end section 122 to the first end section 121. The first direction coincides with a direction extending from the back to the front. The first direction refers to a direction extending from top to bottom in FIG. 6. That is, the outer peripheral section 1e is inclined downward with respect to the inner peripheral section 1i.

The length of the inner peripheral section 1i in the width direction of the flat wire 1 is, for example, 30% or more and 75% or less of the width of the flat wire 1, and 40% or more and 70% or less thereof. The length of the outer peripheral section 1e in the width direction of the flat wire 1 is, for example, 25% or more and 70% or less of the width of the flat wire 1, and 30% or more and 60% or less thereof.

### <Displacement Amount>

A displacement amount 1d between the inner peripheral section 1i and the outer peripheral section 1e in the axial direction of the main body portion 110 is, for example, 0.1 mm or more and 0.5 mm or less, and 0.2 mm or more and 0.4 mm or less. The displacement amount 1d refers to the amount of displacement at a corner section of a turn 2. The displacement amount at a straight section of a turn 2 may be smaller than the displacement amount at a corner section of the turn 2. The corner section refers to a corner section 20c shown in FIG. 5. The straight section refers to a straight section 20s shown in FIG. 5.

All of the displacement amounts 1d at the plurality of turns 2 may be the same. Out of the plurality of turns 2, the displacement amounts 1d at some turns 2 may differ from the displacement amounts 1d at at least some of the remaining turns 2.

The displacement amount 1d can be measured using, for example, a laser distance meter as follows. The coil 10 is placed on a horizontal table so that the axial direction of the main body portion 110 is perpendicular. The coil 10 is disposed such that the first end section 121 is located at the bottom and the second end section 122 is located at the top. The distance from a reference position above the coil 10 to an intersection point between an upper surface and a side surface of the inner peripheral section 1i is measured. This distance is used as a first distance. A side surface of the inner peripheral section 1i is an inner peripheral surface of the turn 2, and corresponds to one short side of a rectangular shape of a cross-section of the flat wire 1. The distance from the reference position to an intersection point between an upper surface and a side surface of the outer peripheral section 1e is measured. This distance is used as a second distance. A side surface of the outer peripheral section 1e is an outer peripheral surface of the turn 2, and corresponds to one short side of a rectangular shape of a cross-section of the flat wire 1. The difference between the first distance and the second distance is set to the displacement amount 1d. Then, the displacement amounts 1d at all of the corner sections 20c of the turns 2 are measured. According to this embodiment, the displacement amounts 1d at four corner sections 20c shown in FIG. 5 are measured. The average of the measured displacement amounts 1d at all of the corner sections 20c is used as the displacement amount 1d at the turn 2.

In this embodiment, as described with reference to FIG. 6, the flat wire 1 forming the turns 2 in the main body portion 110 is bent partway in the width direction. Accordingly, as shown in FIG. 7, the first terminal section 131 of the first end section 121 is open in the first direction of the axial direction of the main body portion 110. Specifically, the first end section turn 2a that is continuous with the first terminal section 131 is distanced from a turn 2 that is adjacent to the first end section turn 2a. The reason as to why the first terminal section 131 is open in the first direction in this manner will be described in a method for manufacturing a coil, which will be described later.

Furthermore, in this embodiment, as shown in FIG. 6, a gap 2g between turns 2 can be reduced by bending the flat wire 1 forming the turns 2 partway in the width direction of the flat wire 1. The reason as to why the gap 2g is reduced will be described in the later-described method for manufacturing a coil.

The gap 2g is 0.076 mm or less, 0.06 mm or less, or 0.05 mm or less, for example. The smaller the gap 2g is, the shorter the length of the main body portion 110 is. Therefore, a lower limit thereof is not provided. That is, the lower limit is zero.

The gap 2g can be obtained as the average of the gaps 2g between all of the turns 2, excluding the first end section turn 2a. The gap 2g can be obtained as [(L₁−n₁×t)/(n₁−1)]. L₁ is the length (mm) of the main body portion 110 that does not include the first end section turn 2a. n₁ is the number of turns 2 excluding the first end section turn 2a. t is the thickness (mm) of the flat wire 1.

The length L₁ of the main body portion 110 is measured as follows. A straight line that is parallel to the axial direction of the main body portion 110 is drawn at a position in the circumferential direction of the outer peripheral surface of the main body portion 110. This straight line is a virtual straight line that is in contact with outer peripheral surfaces of the turns 2. Out of the turns 2 on the straight line, the distance between turns 2 located at two ends of the main body portion 110, excluding the first end section turn 2a, is determined. This distance is set to the length L₁. The length L₁ of the main body portion 110 is preferably measured while the coil 10 is placed on a horizontal table so that the axial direction of the main body portion 110 is horizontal. Measurement is performed in a state in which no load is applied to the main body portion 110. The number n₁ of turns 2 refers to the number of turns 2 that intersect the straight line, excluding the first end section turn 2a. The value (n₁−1) represents the number of gaps 2g between turns 2 that do not include the first end section turn 2a.

### (Method for Manufacturing Coil)

A method for manufacturing the above-described coil 10 will be described below mainly with reference to FIGS. 8 to 12. The coil 10 can be manufactured using a winding machine. A known winding machine can be used as the winding machine.

### (Winding Machine)

The winding machine includes a bending-processing portion 800 shown in FIG. 8, and a feeding mechanism (not shown). The bending-processing portion 800 performs edgewise bending on the flat wire 1. The feeding mechanism feeds the flat wire 1. The bending-processing portion 800 is one main portion of the winding machine.

### (Bending-Processing Portion)

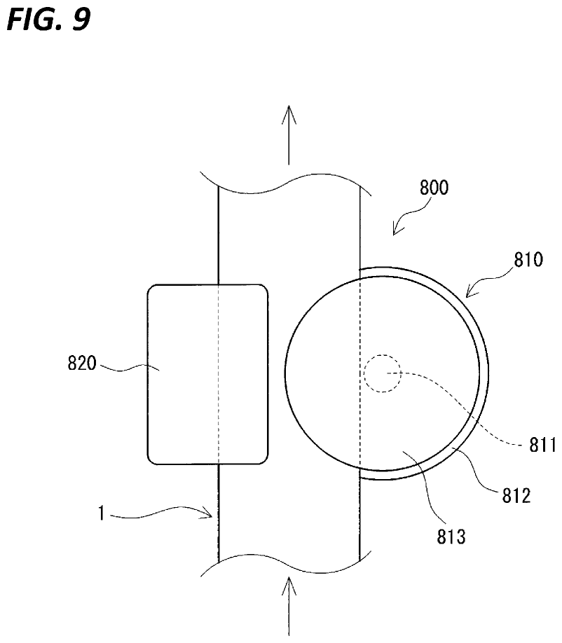

As shown in FIGS. 8 and 9, the bending-processing portion 800 includes a holding portion 810 and a guide portion 820. The holding portion 810 holds an inner peripheral portion 1i of the flat wire 1. An inner peripheral section 1i of the flat wire 1 is a portion of the flat wire 1 located on the inner peripheral side of a bent portion of the flat wire 1 when the flat wire 1 is bent edgewise. The guide portion 820 holds the outer peripheral section 1e of the flat wire 1. The outer peripheral section 1e of the flat wire 1 is a portion of the flat wire 1 located on the outer peripheral side of the bent portion of the flat wire 1.

### <Holding Portion>

The holding portion 810 includes a shaft 811 and a support body 812 that supports the shaft 811. The shaft 811 is a round columnar member that comes into contact with a side surface of the inner peripheral section 1i of the flat wire 1. The side surface of the inner peripheral section 1i is a surface that corresponds to one short side of a rectangular shape of a cross-section of the flat wire 1. The support body 812 is cylindrical. The shaft 811 extends through the center of the support body 812. The shaft 811 is slidable in the axial direction of the shaft 811 with respect to the support body 812. A leading end of the shaft 811 protrudes from an end surface of the support body 812. The leading end of the shaft 811 has a circular plate-shaped flange 813. The support body 812 and the flange 813 are spaced apart from each other.

The holding portion 810 includes a first surface 812f constituted by an end surface of the support body 812, and a second surface 813f constituted by a surface of the flange 813 facing the support body 812. The first surface 812f and the second surface 813f are disposed facing each other so as to hold the inner peripheral section 1i of the flat wire 1 in the thickness direction. The inner peripheral section 1i of the flat wire 1 is passed between and held by the first surface 812f and the second surface 813f. A slight clearance is provided between the first surface 812f and the inner peripheral section 1i, and between the second surface 813f and the inner peripheral section 1i, so that the flat wire 1 can pass therethrough when the flat wire 1 is fed out.

### <Guide Portion>

The guide portion 820 is revolvable about the central axis of the shaft 811 serving as a rotational center. The guide portion 820 is provided with a guide groove 821 so as to hold the inner peripheral section 1i of the flat wire 1 in the thickness direction. The outer peripheral section 1e of the flat wire 1 is passed through and held by the guide groove 821. The width of the guide groove 821 is slightly larger than the thickness of the outer peripheral section 1e of the flat wire 1 such that the flat wire 1 can pass therethrough when the flat wire 1 is fed out.

In this embodiment, the guide portion 820 is slidable in the axial direction of the shaft 811 with respect to the holding portion 810. The position of the guide portion 820 is controlled by a drive device (not shown), for example. The drive device is a servo motor, for example.

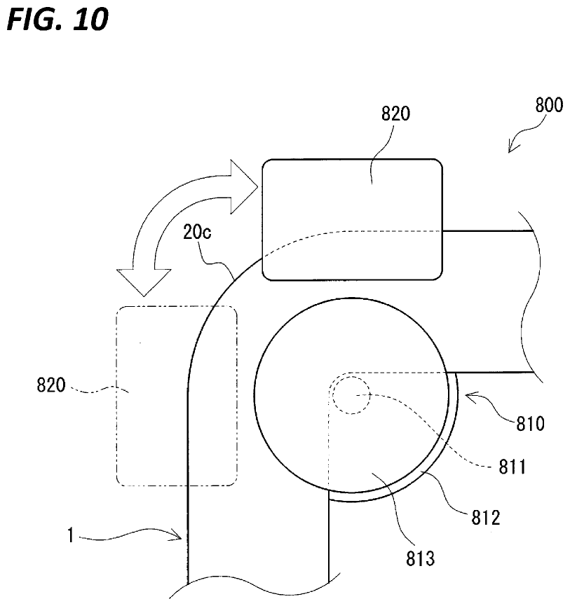

Operation of the bending-processing portion 800 when edgewise bending the flat wire 1 will be described below with reference to FIGS. 9 and 10. Here, a case of forming a rectangular tubular coil 10 shown in FIGS. 3 and 5 will be described as an example. In FIGS. 9 and 10, the bending-processing portion 800 is viewed from the flange 813 side, that is, the bending-processing portion 800 is viewed in the axial direction of the shaft 811 from the lower side in FIG. 8. As shown in FIG. 9, the flat wire 1 is fed linearly using a feeding mechanism (not shown). The arrows in FIG. 9 indicate the direction in which the flat wire 1 is fed. Then, as shown in FIG. 10, the guide portion 820 revolves about the central axis of the shaft 811 serving as a rotational center. The side surface of the inner peripheral section 1i is pressed against the outer peripheral surface of the shaft 811, and thus the flat wire 1 is bent along the outer peripheral surface of the shaft 811. As a result, corner sections where the flat wire 1 is bent edgewise are formed. In this embodiment, the flat wire 1 is bent by 90 degrees by revolving the guide portion 820 by 90 degrees. One turn 2 is formed by repeating this operation. A rectangular turn 2 is formed by repeating the instance of feeding and edgewise bending of the flat wire 1 four times. The coil 10 is then formed by forming a plurality of turns 2 by repeatedly forming the turn 2 several times.

As shown in FIG. 8, when the flat wire 1 is fed out, the support body 812 and the flange 813 are kept at a distance such that a gap is formed between the inner peripheral section 1i of the flat wire 1 and the support body 812, and a gap is formed between the inner peripheral section 1i and the flange 813. While the flat wire 1 is being subjected to edgewise bending, the support body 812 and the flange 813 are brought closer to a distance such that the inner peripheral section 1i of the flat wire 1 is sandwiched therebetween from top and bottom. When the flat wire 1 is bent edgewise, the flat wire 1 deforms such that the inner peripheral side of a bent portion protrudes in the thickness direction, thus thickening the inner peripheral section 1i. By sandwiching the inner peripheral section 1i of the flat wire 1 between the support body 812 and the flange 813 in the thickness direction of the flat wire 1, it is possible to inhibit the inner peripheral section 1i of the flat wire 1 from thickening during edgewise bending.

In general, as shown in FIG. 8, when a coil is produced using a winding machine, a positional relationship between the holding portion 810 and the guide portion 820 is set such that, in the axial direction of the shaft 811, the position at which the inner peripheral section 1i of the flat wire 1 is held substantially coincides with the position at which the outer peripheral section 1e of the flat wire 1 is held. That is, the guide portion 820 is positioned relative to the holding portion 810 such that the inner peripheral section 1i and the outer peripheral section 1e of the flat wire 1 are flat. The position of the guide portion 820 in this case is used as a reference position of the guide portion 820. The reference position refers to a position where a center line between the first surface 812f and the second surface 813f when the holding portion 810 holds the inner peripheral section 1i of the flat wire 1 is aligned with a center line of the width of the guide groove 821 of the guide portion 820.

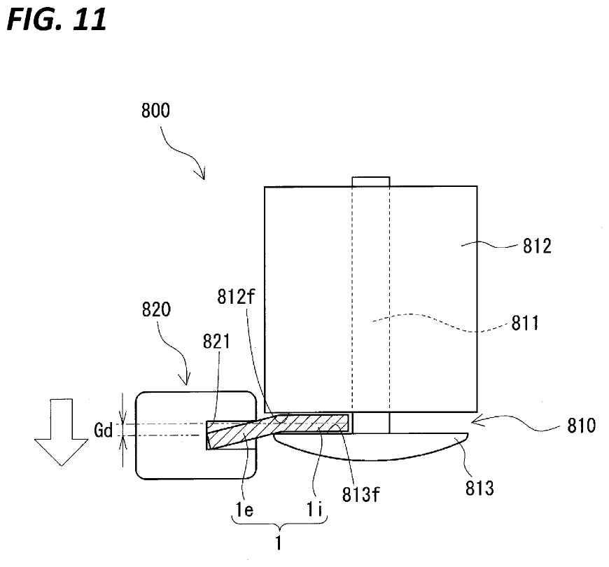

Details of the above-described method for manufacturing the coil 10 will be described below. In the method for manufacturing the coil 10, a winding machine provided with the above-described bending-processing portion 800 is used. The method for manufacturing the coil 10 includes a process of forming a plurality of turns 2 by helically winding the flat wire 1 edgewise. One of the characteristics of the method for manufacturing the coil 10 is that, as shown in FIG. 11, the turn 2 is formed in a state in which the guide portion 820 is displaced in a specific direction with respect to the holding portion 810. The following description will be given with reference to FIGS. 5 to 7 as appropriate.

In this embodiment, winding of the flat wire 1 is started from the first end section 121 side of the main body portion 110. That is, first, the first end section turn 2a is formed. When the first end section turn 2a is formed, a portion of the flat wire 1 is fed out to be the first terminal section 131 shown in FIGS. 5 and 7. The amount of the flat wire 1 fed out at this time is a length including the first terminal section 131 and one straight section 20s. After the flat wire 1 is fed out linearly, the flat wire 1 is bent edgewise to form a corner section 20c. Thereafter, as described with reference to FIGS. 9 and 10, the first end section turn 2a is formed by repeating the instance of feeding and edgewise bending of the flat wire 1. The turn 2 is then formed successively by repeating this operation. The main body portion 110 is formed by forming a predetermined number of turns 2. The second end section turn 2b, which is to be a final turn 2, is formed, and a portion of the flat wire 1, which is to be the second terminal section 132, is then fed out.

As shown in FIG. 11, the process of forming the turns 2 is performed in a state in which the guide portion 820 is displaced with respect to the holding portion 810 in the first direction of the axial direction of the shaft 811. Specifically, by sliding the guide portion 820 downward relative to the holding portion 810, the guide portion 820 is displaced downward with respect to the holding portion 810. That is, the first direction refers to a direction extending from top to bottom in FIG. 11. By displacing the guide portion 820 downward with respect to the holding portion 810, the flat wire 1 can be bent such that the outer peripheral section 1e of the flat wire 1 is inclined downward with respect to the inner peripheral section 1i. As shown in FIG. 6, the turns 2, where the outer peripheral section 1e is inclined downward with respect to the inner peripheral section 1i, can be formed by forming the turns 2 in this state.

The guide portion 820 remains displaced while the turn 2 is being formed. That is, the positional relationship between the holding portion 810 and the guide portion 820 is maintained. Because the inner peripheral section 1i of the flat wire 1 is sandwiched between the support body 812 and the flange 813 during edgewise bending, the flat wire 1 is bent at the corner section 20c of the turn 2. On the other hand, when the flat wire 1 is fed out, the support body 812 and the flange 813 are kept at a distance such that a gap is formed between the inner peripheral section 1i of the flat wire 1 and the support body 812, and a gap is formed between the inner peripheral section 1i and the flange 813. Therefore, it is conceivable that, compared to the corner section 20c, a force for bending the flat wire 1 is less likely to be applied to the straight section 20s of the turn 2, and thus the amount of bending of the straight section 20s of the flat wire 1 may be reduced. In this embodiment, even when the flat wire 1 is fed out, the guide portion 820 also remains displaced by a portion of the flat wire 1 that is to be the first terminal section 131 and a portion thereof that is to be the second terminal section 132.

The flat wire 1 for forming the turns 2 is bent partway in the width direction of the flat wire 1 by displacing the guide portion 820 with respect to the holding portion 810. The gap 2g between turns 2 can be reduced by bending the flat wire 1 partway in the width direction of the flat wire 1 when forming the turns 2. The reasons for this are not clear, but the following is conceivable. It is presumed that, as a result of the flat wire 1 being bent in the width direction, a pulling force is applied to the turn 2 in the direction in which the flat wire 1 is bent, thus narrowing the distance between turns 2. When the above-described displacement amount 1d at the turn 2 is 0.1 mm or more, the effect of reducing the gap 2g is more likely to be obtained. Also, when the displacement amount 1d is 0.5 mm or less, the fact that the flat wire 1 is bent partway in the width direction is less likely to be recognizable. That is, a coil having a good appearance comparative to that of a conventional coil can be easily obtained. The displacement amount 1d may be 0.2 mm or more and 0.4 mm or less, for example.

Furthermore, as shown in FIG. 7, by bending the flat wire 1 partway in the width direction, the first terminal section 131 of the first end section 121 is open in the first direction of the axial direction of the main body portion 110. Specifically, the first end section turn 2a that is continuous with the first terminal section 131 is distanced from a turn 2 that is adjacent to the first end section turn 2a. The reasons as to why the first terminal section 131 is open are conceivable as follows. When the first end section turn 2a is first formed, a portion of the flat wire 1, which is to be the first terminal section 131, is fed out. At this time, the first terminal section 131 and the straight section 20s that is continuous with the first terminal section 131 are linear. By bending the flat wire 1 in the width direction at the corner section 20c of the first end section turn 2a, the corner section 20c of the first end section turn 2a comes into contact with a corner section 20c of the turn 2 wound thereafter. Therefore, a gap is formed between the first end section turn 2a and the next turn 2. Each of the plurality of turns 2, which are wound after the first end section turn 2a, wound in chronological order, are pulled toward an immediately previously wound turn 2 as a result of the immediately previously wound turn 2 being bent in the width direction of the flat wire 1. This resulting tension acts on a portion between adjacent turns 2, thus narrowing the distance between the turns 2. The first end section turn 2a, which is the first turn 2, is not influenced by the immediately previously wound turn 2. Therefore, the first end section turn 2a is kept away from the turn 2, which is wound next. When the above-described displacement amount 1d at the turn 2 is 0.1 mm or more, the first terminal section 131 is more likely to be open in the first direction. The larger the displacement amount 1d at the turn 2 is, the more open the first terminal section 131 is. The displacement amount 1d at the turn 2 may be 0.2 mm or more.

A displacement amount Gd of the guide portion 820 based on the holding portion 810 may be 0.1 mm or more and 0.5 mm or less, and 0.2 mm or more and 0.4 mm or less, for example. The displacement amount Gd of the guide portion 820 refers to the distance by which the guide portion 820 is slid in the axial direction of the shaft 811 from the above-described reference position. The displacement amount Gd refers to the amount of displacement in the first direction, that is, the amount of displacement downward.

The width of the inner peripheral section 1i of the flat wire 1 held by the holding portion 810 is, for example, 30% or more and 75% or less of the width of the flat wire 1, and 40% or more and 70% or less thereof. The width of the outer peripheral section 1e of the flat wire 1 held by the guide portion 820 is, for example, 25% or more and 70% or less of the width of the flat wire 1, and 30% or more and 60% or less thereof.

### (Magnetic Core)

A configuration of the magnetic core 30 will be described below with reference to FIGS. 1 and 2. The coil 10 is disposed in the magnetic core 30. The magnetic core 30 in this embodiment has a θ-shape overall. The magnetic core 30 includes a middle core portion 300, a first end core portion 310, a second end core portion 320, a first side core portion 330, and a second side core portion 340. In this embodiment, the magnetic core 30 is an assembly of a first core 31 and a second core 32. The first core 31 and the second core 32 will be described later.

### (Middle Core Portion)

The middle core portion 300 is a portion of the magnetic core 30 disposed inward of the coil 10. That is, the middle core portion 300 corresponds to the inner core portion. In this embodiment, the middle core portion 300 is divided into two in the longitudinal direction of the middle core portion 300, and has a first middle core portion 301 and a second middle core portion 302. A gap portion 30g is provided partway in the longitudinal direction of the middle core portion 300. The gap portion 30g is disposed between the first middle core portion 301 and the second middle core portion 302. The gap portion 30g may be an air gap, or a plate member made of a nonmagnetic material such as a resin or ceramic material. Unlike this embodiment, the middle core portion 300 need not be provided with the gap portion 30g.

### (First End Core Portion and Second End Core Portion)

The first end core portion 310 is a portion of the magnetic core 30 that faces the first end section 121 of the coil 10. The second end core portion 320 is a portion of the magnetic core 30 that faces the second end section 122 of the coil 10. The first end core portion 310 and the second end core portion 320 are spaced apart from each other so as to hold the coil 10 in the axial direction.

### (First Side Core Portion and Second Side Core Portion)

The first side core portion 330 and the second side core portion 340 are disposed outside the coil 10 so as to hold the middle core portion 300 in the magnetic core 30. The first side core portion 330 and the second side core portion 340 are spaced apart from each other so as to hold two side surfaces of the coil 10 extending in the axial direction. The first side core portion 330 and the second side core portion 340 each have a length such that the first end core portion 310 and the second end core portion 320 are connected to each other.

### (First Core and Second Core)

The magnetic core 30 is constituted by combining the first core 31 and the second core 32 together. The shapes of the first core 31 and the second core 32 can be selected from various combinations. In this embodiment, the type of magnetic core 30 is an E-T type obtained by combining an E-shaped first core 31 and a T-shaped second core 32. Examples of other combinations include an E-U type, an E-I type, and a T-U type.

In this embodiment, the first core 31 includes all of the first end core portion 310, the first middle core portion 301, which is a part of the middle core portion 300, the first side core portion 330, and the second side core portion 340. The first end core portion 310, the first middle core portion 301, the first side core portion 330, and the second side core portion 340 are formed as a single body. The second core 32 includes the second end core portion 320, and the second middle core portion 302, which is the remaining part of the middle core portion 300. The second end core portion 320 is formed as a single body with the second middle core portion 302.

### (Holding Member)

An overview of the holding member 40 will be described below with reference to FIGS. 4, 7, and 12. A configuration of the coil 10 will be described below with reference to FIGS. 3 and 5 as appropriate. A configuration of the magnetic core 30 will be described below with reference to FIGS. 1 and 2 as appropriate. The configuration of the coil 10, the configuration of the holding member 40, and the configuration of the magnetic core 30 are schematically shown in a simplified manner in FIG. 12. FIG. 12 only shows an inner core portion 30i of the magnetic core 30 that is disposed inward of the coil 10. The inner core portion 30i corresponds to the middle core portion 300 of the magnetic core 30. In this embodiment, the holding members 40 are respectively disposed on two end sections of the coil 10. The first holding member 40a is disposed on the first end section 121 of the main body portion 110. The second holding member 40b is disposed on the second end section 122 of the coil 10.

### (First Holding Member)

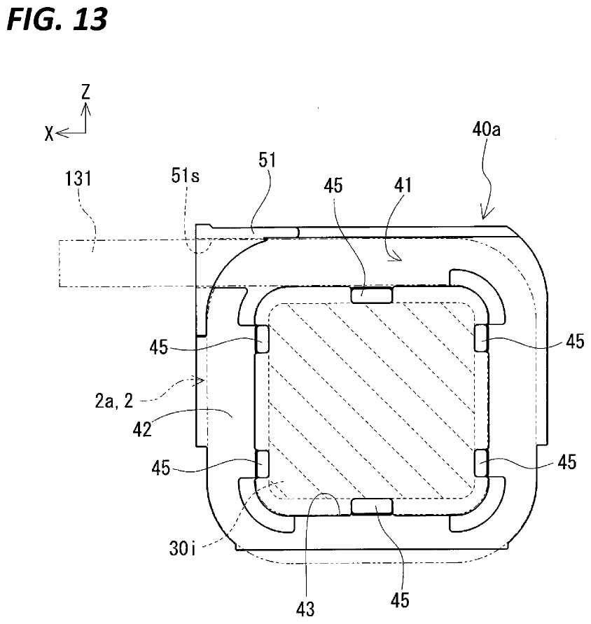

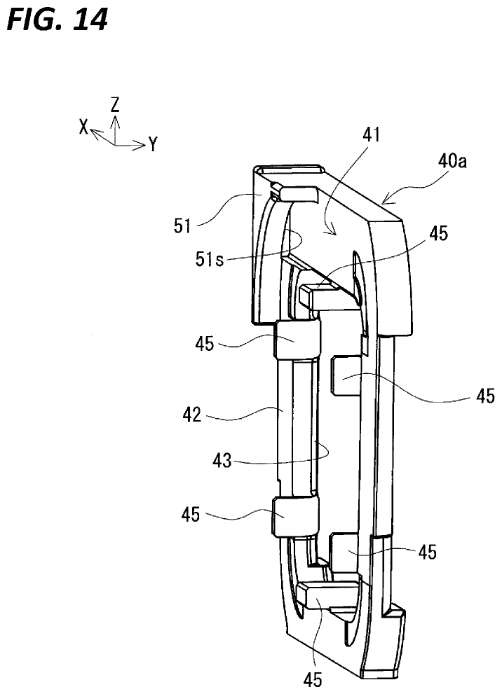

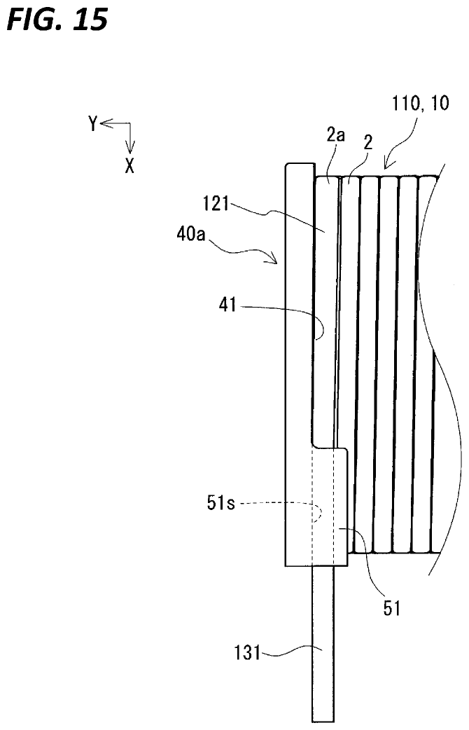

As shown in FIG. 2, the first holding member 40a is disposed between the end surface of the main body portion 110 located on the first end section 121 side and the first end core portion 310 of the magnetic core 30. The first holding member 40a ensures electrical insulation between the main body portion 110 and the first end core portion 310. Hereinafter, a configuration of the first holding member 40a will be described with reference to FIGS. 13 to 15. FIG. 13 is a diagram of the first holding member 40a as seen from the inner side thereof. FIG. 14 is a perspective view of the first holding member 40a as seen from the inner side thereof. The inner side of the first holding member 40a refers to the side where the first holding member 40a faces the end surface of the main body portion 110 located on the first end section 121 side shown in FIG. 3. That is, the inner side of the first holding member 40a faces the first end section turn 2a. The outer side of the first holding member 40a faces the first end core portion 310. The inner side of the first holding member 40a is the back side. The outer side of the first holding member 40a is the front side. The first terminal section 131 and the first end section turn 2a are indicated using line-double dash lines in FIG. 13. Some turns 2 including the first end section turn 2a are indicated using solid lines in FIG. 15.

As shown in FIGS. 13 and 14, the first holding member 40a is a frame-shaped member. The shape of the first holding member 40a is a shape corresponding to the end surface of the main body portion 110. In this embodiment, the first holding member 40a has a rectangular frame shape.

### <First Surface>

The first holding member 40a has a first surface 41. As shown in FIG. 13, the first surface 41 faces the first end section turn 2a that constitutes the end surface of the main body portion 110 located on the first end section 121 side.

The first surface 41 has a first region 42. The first region 42 is a region of the first surface 41 that is in contact with the first end section turn 2a. The first region 42 presses the first end section turn 2a that is in contact with the first surface 41 in the second direction of the axial direction of the main body portion 110. The second direction is the direction opposite to the above-described first direction. That is, the second direction is a direction extending from the first end section 121 to the second end section 122. In other words, the second direction is a direction in which the first end section turn 2a approaches the adjacent turn 2. The second direction coincides with the direction extending from the front to the back. In this embodiment, as shown in FIG. 14, the first region 42 is inclined helically so as to correspond to the first end section turn 2a. As shown in FIG. 12, when the first holding member 40a is assembled to the coil 10, the first end section turn 2a can be pressed in the second direction by the first region 42. When the first end section turn 2a is pressed, the first terminal section 131 is corrected in a direction orthogonal to the axial direction of the main body portion 110.

### <Fixing Portion>

The first holding member 40a has a fixing portion 51. The fixing portion 51 holds the first terminal section 131. The fixing portion 51 is formed at a portion where the first terminal section 131 is drawn out from the first end section turn 2a. In this embodiment, as shown in FIG. 4, the fixing portion 51 is provided at an upper right corner section of the first holding member 40a as seen from front. The right side of the first holding member 40a refers to the right side in FIG. 4, for example. The right side of the first holding member 40a refers to the left side in FIG. 13. The fixing portion 51 covers a portion of the outer peripheral surface of the first end section 121 of the main body portion 110.

The fixing portion 51 has a slit 51s. The first terminal section 131 is passed through the slit 51s. The slit 51s extends in a direction that is orthogonal to the axial direction of the main body portion 110. The slit 51s is open to a side surface of the first holding member 40a. An opening shape of the slit 51s is a shape corresponding to a cross-section of the flat wire 1. The opening shape of the slit 51s refers to the shape of a contour of the slit 51s as seen in the axial direction of the slit 51s. In this embodiment, the opening shape of the slit 51s is rectangular. The slit 51s allows clearance for inserting the first terminal section 131 into the slit 51s. It is not intended that the fixing portion 51 holds the first terminal section 131 completely immovable. That is, movement of the first terminal section 131 in the axial direction of the main body portion 110 in the slit 51s is permitted to an extent that connection between the first terminal section 131 and the busbar 61 is not hindered.

The slit 51s is formed to surround the entire peripheral surface of the first terminal section 131. As shown in FIG. 15, a portion of the inner peripheral surface of the slit 51s located on the first surface 41 side is flush with the first surface 41.

### <Through Hole>

The first holding member 40a has a through hole 43. An end portion of the inner core portion 30i shown in FIG. 12 is inserted into the through hole 43. The shape of the through hole 43 is a shape that substantially corresponds to an outer peripheral shape of the end portion of the inner core portion 30i. In this embodiment, the shape of the through hole 43 is rectangular.

### <Inner Protrusion>

Further, the first holding member 40a has inner protrusions 45. The inner protrusions 45 are disposed between the main body portion 110 and the inner core portion 30i. The inner protrusions 45 protrude in the axial direction of the through hole 43 from the inner peripheral surface of the first holding member 40a that constitutes the through hole 43. As shown in FIG. 13, when the inner core portion 30i is disposed inward of the main body portion 110, a gap is formed by the inner protrusions 45 between the inner peripheral surface of the main body portion 110 and the outer peripheral surface of the inner core portion 30i. The gap ensures electrical insulation between the main body portion 110 and the middle core portion 300. Also, when the first holding member 40a is assembled to the coil 10, the first holding member 40a can be positioned with respect to the coil 10 by the inner protrusions 45. There are no particular limitations on the number or positions of inner protrusions 45. The inner protrusions 45 may be formed at positions corresponding to each side of the inner peripheral surface of the main body portion 110. In this embodiment, the inner protrusions 45 are provided on the inner peripheral surface of the first holding member 40a, one inner protrusion 45 being provided on an upper side and a lower side of the inner peripheral surface, and two inner protrusions 45 being provided on each other side.

### (Method for Assembling First Holding Member)

A method for assembling the first holding member 40a will be described below with reference to FIGS. 7 and 12. As shown in FIG. 7, the first holding member 40a is slid in a direction extending along an end surface of the main body portion 110 with respect to the first end section 121 of the main body portion 110. By sliding the first holding member 40a, the first terminal section 131 can be inserted into the slit 51s. The first holding member 40a is fitted to the first end section 121 by sliding the first holding member 40a and then pressing the first holding member 40a against the first end section 121 of the main body portion 110. As a result, as shown in FIG. 12, the first holding member 40a can be assembled to the first end section 121 of the main body portion 110. Because the first end section turn 2a is spaced away from the adjacent turn 2, the first terminal section 131 can be readily inserted into the slit 51s. In the state in which the first holding member 40a is assembled to the coil 10, the first end section turn 2a is pressed against the first holding member 40a and thus elastically deformed, resulting in the state in which the first terminal section 131 is closed. Although the first end section turn 2a is illustrated as being separated from the adjacent turn 2 in FIG. 12, actually, the first end section turn 2a is in contact with the adjacent turn 2 due to the first end section turn 2a being pressed against the first holding member 40a.

### (Second Holding Member)

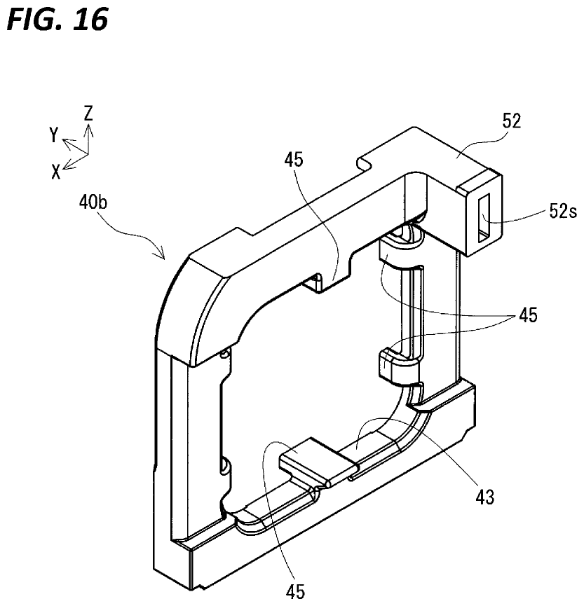

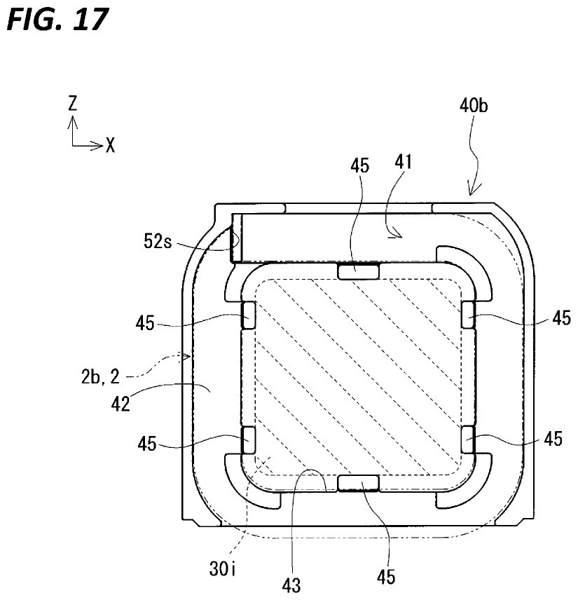

As shown in FIG. 2, the second holding member 40b is disposed between the end surface of the main body portion 110 located on the second end section 122 side and the second end core portion 320 of the magnetic core 30. The second holding member 40b ensures electrical insulation between the main body portion 110 and the second end core portion 320. Hereinafter, a configuration of the second holding member 40b will be described with reference to FIGS. 16 and 17. FIG. 16 is a perspective view of the second holding member 40b as seen from the outer side thereof. FIG. 17 is a diagram of the second holding member 40b as seen from the inner side thereof. The inner side of the second holding member 40b refers to the side where the second holding member 40b faces the end surface of the main body portion 110 located on the second end section 122 side shown in FIG. 3. That is, the inner side of the second holding member 40b faces the second end section turn 2b. The outer side of the second holding member 40b faces the second end core portion 320. The inner side of the second holding member 40b is the front side. The outer side of the second holding member 40b is the back side. The second terminal section 132 and the second end section turn 2b are indicated using line-double dash lines in FIG. 17. A configuration of the second holding member 40b is similar to the above-described configuration of the first holding member 40a. Differences between the second holding member 40b and the first holding member 40a will mainly be described below. Constituent elements common to the first holding member 40a are given the same reference numerals and detail thereof will not be described.

As shown in FIGS. 16 and 17, the second holding member 40b is a frame-shaped member. Similar to the first holding member 40a, a shape of the second holding member 40b is rectangular-frame shaped.

### <First Surface>

The second holding member 40b has a first surface 41. As shown in FIG. 17, the first surface 41 faces the second end section turn 2b that constitutes the end surface of the main body portion 110 located on the second end section 122 side. Similarly to the first holding member 40a, the first surface 41 has a first region 42 that is in contact with the second end section turn 2b. The first region 42 presses the second end section turn 2b that is in contact with the first surface 41 in the first direction of the axial direction of the main body portion 110. The first direction is a direction extending from the second end section 122 to the first end section 121. In other words, the first direction is a direction in which the second end section turn 2b approaches the adjacent turn 2. Although not shown in FIG. 17, the first region 42 is inclined helically so as to correspond to the second end section turn 2b. As shown in FIG. 12, when the first holding member 40a is assembled to the coil 10, the second end section turn 2b can be pressed in the first direction by the first region 42.

### <Fixing Portion>

The second holding member 40b has a fixing portion 52. The fixing portion 52 holds the second terminal section 132. The fixing portion 52 is formed at a portion where the second terminal section 132 is drawn out from the second end section turn 2b. In this embodiment, as shown in FIG. 4, the fixing portion 52 is provided at an upper left corner section of the second holding member 40b as seen from front. The left side of the second holding member 40b refers to the right side in FIG. 16, for example. The left side of the second holding member 40b refers to the left side in FIG. 17. As shown in FIG. 16, the fixing portion 52 protrudes in the axial direction from an outer surface of the second holding member 40b.

The fixing portion 52 has a slit 52s. The second terminal section 132 is passed through the slit 52s. The slit 52s extends in a direction extending in the axial direction of the main body portion 110. The slit 52s is open to the outer surface of the second holding member 40b. An opening shape of the slit 52s is a shape corresponding to a cross-section of the flat wire 1, i.e., a rectangular shape. The slit 52s is formed to surround the entire peripheral surface of the second terminal section 132. As shown in FIG. 17, the slit 52s is substantially orthogonal to the first surface 41. The slit 52s allows clearance for inserting the second terminal section 132 into the slit 52s. Similarly to the above-described fixing portion 51, it is not intended that the fixing portion 52 holds the second terminal section 132 completely immovable.

### <Through Hole and Inner Protrusion>

Similarly to the first holding member 40a, the second holding member 40b has a through hole 43 and inner protrusions 45.

### (Method for Assembling Second Holding Member)

A method for assembling the second holding member 40b will be described below with reference to FIGS. 7 and 12. As shown in FIG. 7, the second terminal section 132 is inserted into the slit 52s by moving the second holding member 40b in a direction extending in the axial direction of the main body portion 110. The second holding member 40b is fitted to the second end section 122 by pressing the second holding member 40b against the second end section 122 of the main body portion 110. As a result, as shown in FIG. 12, the second holding member 40b can be assembled to the second end section 122 of the main body portion 110.

The reactor 100 according to the above-described embodiment is capable of regulating the position of the first terminal section 130 of the coil 10 using the holding member 40. In particular, the first terminal section 131, which is drawn out in a direction extending along the end surface of the main body portion 110, is inserted into the slit 51s formed in the fixing portion 51 of the first holding member 40a. Therefore, it is possible to effectively suppress displacement of the first terminal section 131 in the axial direction of the main body portion 110. Thus, the position of the first terminal section 131 is sufficiently regulated.

The first holding member 40a is assembled to the first end section 121 of the main body portion 110 by sliding the first holding member 40a in the direction extending along the end surface of the main body portion 110. Because the first terminal section 131 is inserted into the slit 51s, the first holding member 40a is unlikely to detach from the first end section 121. Also, because a portion of the inner peripheral surface of the slit 51s that is located on the first surface 41 side is flush with the first surface 41, the first terminal section 131 can be readily inserted into the slit 51s, using the first surface 41 as a guide.

As for the turns 2 that constitute the main body portion 110 of the coil 10, each outer peripheral section 1e of the flat wire 1 is inclined in the first direction with respect to the corresponding inner peripheral section 1i. Because the flat wire 1 forming the turns 2 are bent partway in the width direction, the first terminal section 131 is likely to be open in the first direction of the axial direction of the main body portion 110 in the state where nothing is assembled to the coil 10. When the first holding member 40a is assembled to the first end section 121 by sliding the first holding member 40a, the first terminal section 131 can be readily inserted into the slit 51s. The first holding member 40a can be readily assembled to the first end section 121.

Furthermore, a gap 2g between turns 2 can be reduced by bending the flat wire 1 forming the turns 2 partway in the width direction of the flat wire 1. Because the size of the gap 2g is small, the entire length of the main body portion 110 is unlikely to be short when the main body portion 110 is pressed in the axial direction from two end sections. After the holding members 40 are assembled to the coil 10, the position of the first terminal section 131 and the position of the second terminal section 132 remain almost unchanged.

Because the displacement amount 1d between the inner peripheral section 1i and the outer peripheral section 1e of a turn 2 is 0.1 mm or more, the first terminal section 131 is likely to be open in the first direction, and the gap 2g is likely to decrease in size. Because the displacement amount 1d is 0.5 mm or less, the fact that the flat wire 1 is bent partway in the width direction is less likely to be recognizable. That is, it is possible to obtain a coil 10 having a good appearance comparative to that of a conventional coil.

Because the positional accuracy of the first terminal section 131 in the reactor 100 of this embodiment is improved, the operability for connecting the busbar 61 to the first terminal section 131 is improved. Because the position of the first terminal section 131 and the position of the second terminal section 132 remain almost unchanged, the busbars 61 and 62 can be readily connected respectively to the terminal sections 130 of the first terminal section 131 and the second terminal section 132.

### Sample Examples

The coil 10 was manufactured using the method for manufacturing a coil described in the embodiment. Specifications of the coil 10 manufactured were as follows. The shape of the main body portion 110 was rectangular tubular in shape. The end surface of the main body portion 110 had a rectangular shape. The number of turns 2 was 16.

The width of the inner peripheral section 1i of the flat wire 1 held by the holding portion 810 was about 60% of the width of the flat wire 1. The width of the outer peripheral section 1e of the flat wire 1 held by the guide portion 820 was about 30% of the width of the flat wire 1. The turns 2 were formed in a state in which the guide portion 820 was displaced downward with respect to the holding portion 810. The displacement amount Gd of the guide portion 820 was set to 0.2 mm. The manufactured coil 10 was used as Sample No. 1.

The displacement amount 1d between the inner peripheral section 1i and the outer peripheral section 1e of the turn 2 in Sample No. 1 was measured. The displacement amount 1d was measured using the measurement method described in the embodiment. Then, the average of the displacement amounts 1d at four corner sections 20c was obtained. As a result, the average of the displacement amounts 1d at the corner sections 20c of the turn 2 was about 0.2 mm. Also, the displacement amounts at intermediate points of four straight sections 20s were measured, and the average of the displacement amounts was then obtained. The intermediate point of a straight section 20s was an intermediate point of the length of the straight section 20s extending in the peripheral direction of the turn 2. As a result, the average of the displacement amounts at the straight sections 20s of the turn 2 was about 0.1 mm.

The reasons as to why the displacement amount at the straight sections 20s was smaller than the displacement amount at the corner sections 20c are conceivable as follows. Because the inner peripheral section 1i of the flat wire 1 is sandwiched between the support body 812 and the flange 813 during edgewise bending, the inner peripheral section 1i is fixed. Therefore, the flat wire 1 can be readily bent at a corner section 20c. In contrast, because, at the straight section 20s, the support body 812 and the flange 813 are kept at a distance such that a gap is formed between the inner peripheral section 1i and the support body 812, and a gap is formed between the inner peripheral section 1i and the flange 813, a force for bending the flat wire 1 is less likely to be applied to the straight section 20s, compared to the corner section 20c. It is conceivable that the displacement amount of the straight section 20s is smaller than that of the corner section 20c due to the relationship between the flat wire 1, the holding portion 810, and the guide portion 820.

The appearance of Sample No. 1 was visually examined. As a result, it was not clear that the flat wire in the turn 2 was bent partway in the width direction. Also, in Sample No. 1, a gap was formed between the first end section turn 2a and a turn 2 that was adjacent to the first end section turn 2a at the first end section 121 of the main body portion 110. That is, the first terminal section 131 was open in the first direction. The gap between the first end section turn 2a and the adjacent turn 2 was about 1.0 mm. The gap was the widest part of the gap between the first end section turn 2a and the adjacent turn 2. As for Sample No. 1, the first holding member 40a was readily assembled to the first end section 121 of the main body portion 110.

As for Sample No. 1, the gap 2g between turns 2 was measured. The gap 2g was measured using the measurement method described in the above embodiment. As a result, the gap 2g was 0.03 mm.

A coil was manufactured under the same manufacturing conditions as those for Sample No. 1, except that the displacement amount Gd of the guide portion 820 was set to 0 mm. The coil manufactured was used as Sample No. 10.

The gap between the first end section turn 2a and a turn 2 that was adjacent to the first end section turn 2a at the first end section 121 of the main body portion 110 was smaller in Sample No. 10 than in Sample No. 1. Therefore, the first terminal section 131 was not sufficiently open in the first direction. As for Sample No. 10, there was a need to push the first terminal section 131 in a direction away from the adjacent turn 2, for example, in order to assemble the first holding member 40a to the first end section 121 of the main body portion 110, resulting in poor assembling operability. When the first terminal section 131 is pushed out, the first terminal section 131 may bend.

As for Sample No. 10, the gap 2g between turns 2 was also measured. The gap 2g was measured using the measurement method described in the embodiment. As a result, the gap 2g was 0.06 mm. The gap 2g of Sample No. 1 was smaller than the gap 2g of Sample No. 10, and thus Sample No. 1 had high dimensional stability.

### <Converter and Power Conversion Device>

The reactor 100 according to the embodiment can be used for applications that satisfy the following power conduction conditions. The power conduction conditions are, for example, such that the maximum direct current is about 100 A or more and about 1000 A or less, the average voltage is about 100 V or more and about 1000 V or less, and the operating frequency is about 5 kHz or more and about 100 kHz or less. The reactor 100 according to the embodiment can be typically used as a component of a converter mounted in a vehicle such as an electric automobile or a hybrid automobile, or a component of a power conversion device that includes the converter. The reactor 100 according to the embodiment had excellent operability for connecting the terminal section 130 of the coil 10 to the busbars 61 and 62, thus improving the productivity of the converter and the power conversion device.

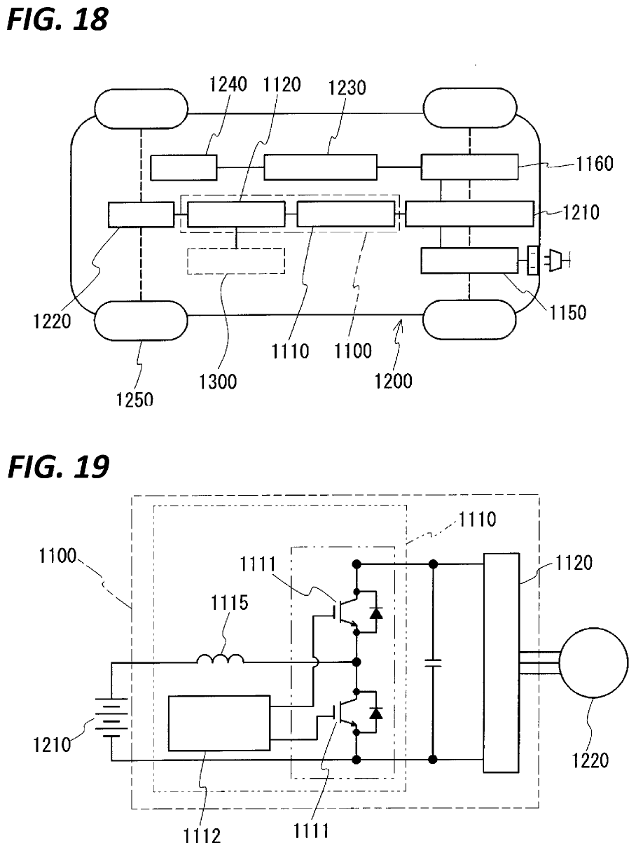

As shown in FIG. 18, a vehicle 1200 such as a hybrid automobile or an electric automobile includes a main battery 1210, a power conversion device 1100 connected to the main battery 1210, and a motor 1220 that is used for traveling and is driven by power supplied from the main battery 1210. The motor 1220 is typically a three-phase AC motor that drives wheels 1250 during travel, and functions as a generator during regeneration. In the case of a hybrid automobile, the vehicle 1200 includes an engine 1300 in addition to the motor 1220. The vehicle 1200 in FIG. 18 includes an inlet as a charging point, but can include a plug instead.

The power conversion device 1100 includes a converter 1110 connected to the main battery 1210, and an inverter 1120 that is connected to the converter 1110 and performs conversion between direct current and alternating current. While the vehicle 1200 is traveling, the converter 1110 shown in this example steps up a voltage of about 200 V or more and about 300 V or less, which is input by the main battery 1210, to about 400 V or more and about 700 V or less, and supplies the boosted power to the inverter 1120. During regeneration, the converter 1110 steps down the input voltage output from the motor 1220 via the inverter 1120 to a DC voltage suitable for the main battery 1210, and charges the main battery 1210. The input voltage is DC voltage. While the vehicle 1200 is traveling, the inverter 1120 converts the DC voltage boosted by the converter 1110 into a predetermined AC voltage and supplies the power to the motor 1220, whereas during regeneration, the inverter 1120 converts AC voltage output from the motor 1220 into DC voltage and outputs the power to the converter 1110.

As shown in FIG. 19, the converter 1110 includes a plurality of switching elements 1111, a drive circuit 1112 that controls the operation of the switching elements 1111, and a reactor 1115, and performs conversion of an input voltage by repeating ON/OFF operations. Here, the conversion of the input voltage refers to stepping up and stepping down of a voltage. Power devices such as field effect transistors or insulated gate bipolar transistors are used as the switching elements 1111. The reactor 1115 utilizes the properties of a coil that attempts to prevent a change in the current that is to flow through the circuit, so as to realize the function of suppressing a current increase or decrease caused by a switching operation. The reactor 100 according to the embodiment is provided as the reactor 1115.

In addition to the converter 1110, the vehicle 1200 includes a power supply device converter 1150 connected to the main battery 1210, and an auxiliary power supply converter 1160 that is connected to a sub battery 1230 serving as a power source for accessories 1240 and the main battery 1210 and converts a high voltage from the main battery 1210 to a low voltage. The converter 1110 typically performs DC-DC conversion, whereas the power supply device converter 1150 and the auxiliary power supply converter 1160 typically perform AC-DC conversion. Some power supply device converters 1150 perform DC-DC conversion. The reactors of the power supply device converter 1150 and the auxiliary power supply converter 1160 have the same configuration as the reactor 100 of the embodiment, and the size, shape, and the like of the reactor can be changed appropriately. Also, the reactor 100 of the embodiment can be used in a converter that performs conversion on input power and only steps up or down a voltage.

List of Reference Numerals

| | |
|---|---|
| 100 | Reactor |
| 10 | Coil |
| 110 | Main body portion |
| 120 | End section |
| 121 | First end section |
| 122 | Second end section |
| 130 | Terminal section |
| 131 | First terminal section |
| 132 | Second terminal section |
| 1 | Flat wire |
| 1i | Inner peripheral section |
| 1e | Outer peripheral section |
| 1b | Bent section |
| 1d | Displacement amount |
| 2 | Turn |
| 20s | Straight section |
| 20c | Corner section |
| 2a | First end section turn |
| 2b | Second end section turn |
| 2g | Gap |
| 30 | Magnetic core |
| 31 | First core |
| 32 | Second core |
| 30i | Inner core portion |
| 30g | Gap portion |
| 300 | Middle core portion |
| 301 | First middle core portion |
| 302 | Second middle core portion |
| 310 | First end core portion |
| 320 | Second end core portion |
| 330 | First side core portion |
| 340 | Second side core portion |
| 40 | Holding member |
| 40a | First holding member |
| 40b | Second holding member |
| 41 | First surface |
| 42 | First region |
| 43 | Through hole |
| 45 | Inner protrusion |
| 51, 52 | Fixing portion |
| 51s, 52s | Slit |
| 61, 62 | Busbar |
| 800 | Bending-processing portion |
| 810 | Holding portion |
| 811 | Shaft |
| 812 | Support body |
| 813 | Flange |
| 812f | First surface |
| 813f | Second surface |
| 820 | Guide portion |
| 821 | Guide groove |
| 1100 | Power conversion device |
| 1110 | Converter |
| 1111 | Switching element |
| 1112 | Drive circuit |
| 1115 | Reactor |
| 1120 | Inverter |
| 1150 | Power supply device converter |
| 1160 | Auxiliary power supply converter |
| 1200 | Vehicle |
| 1210 | Main battery |
| 1220 | Motor |
| 1230 | Sub battery |
| 1240 | Accessories |
| 1250 | Wheels |
| 1300 | Engine |
| Gd | Displacement amount |
| L₁ | Length of main body portion |

1. A reactor comprising:
an edgewise coil constituted by a flat wire;
a magnetic core where the coil is disposed; and
a holding member disposed on at least one end section of the coil,
wherein the coil includes
a main body portion constituted by a plurality of turns; and
a first terminal section that is drawn out from one end section of the main body portion in a direction extending along an end surface of the main body portion,
the plurality of turns each include
an inner peripheral section that constitutes an inner peripheral side of the turn of the flat wire, and
an outer peripheral section that constitutes an outer peripheral side of the turn of the flat wire,
the outer peripheral section is bent to be inclined with respect to the inner peripheral section in a first direction of an axial direction of the main body portion,
the holding member includes
a first surface facing the end surface of the main body portion and
a fixing portion that holds the first terminal section, and
the fixing portion has a slit through which the first terminal section is passed.

2. The reactor according to claim 1,
wherein the plurality of turns each include a corner section obtained by bending the flat wire, and
a displacement amount between the inner peripheral section and the outer peripheral section at the corner section in the axial direction of the main body portion is 0.1 mm or more and 0.5 mm or less.

3. The reactor according to claim 1,
wherein the first surface has a first region, and
the first region presses a turn of the plurality of turns that is in contact with the first surface, in a second direction of the axial direction of the main body portion.

4. A reactor comprising:
an edgewise coil constituted by a flat wire;
a magnetic core where the coil is disposed; and
a holding member disposed on at least one end section of the coil,
wherein the coil includes
a main body portion constituted by a plurality of turns; and
a first terminal section that is drawn out from one end section of the main body portion in a direction extending along an end surface of the main body portion,
the holding member includes
a first surface facing the end surface of the main body portion and
a fixing portion that holds the first terminal section,
the fixing portion has a slit through which the first terminal section is passed,
the first surface has a first region, and
the first region presses a turn of the plurality of turns that is in contact with the first surface, in a second direction of an axial direction of the main body portion.

5. The reactor according to claim 1,
wherein the magnetic core includes an inner core portion disposed inward of the main body portion, and
the holding member includes
a through hole into which an end portion of the inner core portion is inserted, and
an inner protrusion disposed between the main body portion and the inner core portion.

6. A converter comprising
the reactor according to claim 1.

7. A power conversion device comprising
the converter according to claim 6.
